(19) United States
(12) Patent Application Publication
(10) Pub. No.: US 2025/0238728 A1
(43) Pub. Date: Jul. 24, 2025

(54) ARTICLE INSPECTION APPARATUS AND LEARNING MODEL UPDATE SYSTEM

(71) Applicant: ANRITSU CORPORATION, Kanagawa (JP)

(72) Inventors: Takeshi YAMAZAKI, Kanagawa (JP); Junichi TAMURA, Kanagawa (JP); Hirotaka NAKAJIMA, Kanagawa (JP)

(21) Appl. No.: 19/024,465

(22) Filed: Jan. 16, 2025

(30) Foreign Application Priority Data
Jan. 22, 2024 (JP) 2024-007526

(51) Int. Cl. G06N 20/00; G06Q 10/0639

(52) U.S. Cl. CPC G06N 20/00; G06Q 10/06395

(57) ABSTRACT

There are provided a sensor that outputs a detection signal for inspecting a quality state of an article, an inspection unit that inspects the quality state of the article by applying a trained model created by training in advance to the detection signal output by the sensor, update means for updating the trained model based on an external input, evaluation means for evaluating the trained model by using a verification dataset which is not used for training the trained model, and output means for outputting an evaluation result by the evaluation means, as statistical data related to an inspection result by the inspection unit with the verification dataset, and it is possible to quantitatively grasp a deterioration in inspection performance according to the update of the trained model.

### TECHNICAL FIELD

The present invention relates to an article inspection apparatus and a learning model update system, and particularly to an article inspection apparatus that inspects a quality state of an article by applying a trained model to an inspection image or a sensor signal according to the quality state of the article, and a learning model update system that supports an update of the trained model.

### BACKGROUND ART

Recently, an article inspection apparatus has been known that inspects a quality state of an article by applying a so-called artificial intelligence (AI) model which is a learning model trained with machine learning for an inspection image or a sensor signal including a feature amount corresponding to the quality state of the article.

For example, in order to improve article inspection accuracy, there is a technique in which a plurality of images with different input systems are captured under a predetermined imaging condition according to each input system to acquire image data in which the plurality of images of an inspection object are set, and to store the image data in an image storage unit, and in advance, a trained model for inspection determination, which is trained with machine learning using training image data acquired under the same imaging condition as the image data of the inspection object stored in the image storage unit, is created, and the image data of the inspection object acquired during an actual inspection is processed for each pixel by the trained model to obtain a quality defect degree, and the quality defect degree is compared with a preset threshold value to determine a quality state of the inspection object (for example, see Patent Document 1).

In addition, there is a technique in which a pseudo image generation model capable of pseudo-generating X-ray image data in another energy band corresponding to X-ray image data in a predetermined energy band is created based on a training result of X-ray image data in a plurality of energy bands related to a training target item, a pseudo transmission image in another energy band is created by the pseudo image generation model based on X-ray image data of an inspection object acquired at a time of an actual inspection, and a quality state of an article is determined based on the X-ray image data in the predetermined energy band acquired at the time of the actual inspection and the pseudo transmission image in the other energy band created by the pseudo image generation model (for example, see Patent Document 2).

### RELATED ART DOCUMENT

### Patent Document

[Patent Document 1] JP-A-2023-114828
[Patent Document 2] JP-A-2021-148486

### DISCLOSURE OF THE INVENTION

### Problem that the Invention is to Solve

In the article inspection apparatus as described above, the trained learning model (hereinafter, also referred to as a trained model or an AI model) to be used may be updated, for example, by increasing training image data of a non-defective product or a defective product of the inspection article and performing additional training, or the trained model may be re-trained in accordance with an increase or decrease in network layer constituting the trained model, a change in hyper-parameter, or the like.

Meanwhile, inspection performance may deteriorate due to the additional training or the re-training as compared with the currently used AI model, or detection accuracy of the defective product that can be detected by the additional training may be low although the defective product that can be detected with high accuracy by the AI model before the training.

Therefore, in an actual production line, it is necessary to evaluate the performance of the additional trained model by flowing a large number of articles of an inspection object type by test production using the additional trained model, which causes a problem of a loss of food or packaging materials due to the test production.

Therefore, an object of the present invention is to provide an article inspection apparatus capable of quantitatively grasping a deterioration in inspection performance according to an update of a trained model and reliably preventing a deterioration in yield due to an erroneous detection by an inspection unit in advance, in the update of the trained model, and to provide a learning model update system thereof.

### Means for Solving the Problem

In order to achieve the above object, according to a first aspect of the present invention, there is provided an article inspection apparatus including: a sensor that outputs a detection signal for inspecting a quality state of an article which is sequentially transported; an inspection unit that inspects the quality state of the article by applying a trained model created by training in advance to a predetermined detection signal output by the sensor; update means for updating the trained model under a condition in which an update request is input from an outside; evaluation means for evaluating the trained model by using a verification dataset which is not used for training the trained model; and output means for outputting an evaluation result by the evaluation means, as statistical data related to an inspection result by the inspection unit with the verification dataset.

With such a configuration, in the present invention, when the update means updates the trained model for application to the inspection unit via a predetermined medium as an external input, for example, a transmission medium such as a network or a storage medium such as a USB, the trained model before and after the update can be respectively evaluated by the evaluation means by using a verification dataset which is unused for each training. In addition, for the trained model (artificial intelligence (AI) model) before and after the update, each evaluation result is output as statistical data (for example, a detection rate of whether the article is a non-defective product or a defective product (=the number of detections/the number of inspection articles)) related to the inspection result by the inspection unit by using the same verification dataset by the output means. Therefore, it is possible to accurately compare and evaluate the old and new trained models before and after the update based on each evaluation result by using the same verification dataset, and when the entire learning model is re-trained by partially changing a training algorithm or additionally trained by increasing training image data of a non-defective product or a defective product, it is possible to accurately grasp the effect of the re-training or the additional training on inspection performance, and to reliably prevent a deterioration in inspection performance or the like due to the update of the trained model in advance.

The verification dataset referred to here is a prepared collection of data for a specific purpose processed by a program or a learning model having a training algorithm. Meanwhile, the verification dataset is not training data used for updating weighting factors or the like during machine learning for learning model construction, but is an unutilized dataset in which prediction performance of classification or regression by the trained model can be evaluated. The verification dataset includes at least test data for evaluating the trained model after training between the test data and verification data which can be used for calculating accuracy for adjusting a hyper-parameter in a stage of re-training or the like.

According to a second aspect of the present invention, the article inspection apparatus according to the first aspect, further includes: a storage unit that stores a plurality of verification datasets which are not used for training the trained model. In this case, the plurality of verification datasets corresponding to a plurality of types for an inspection object can be stored.

According to a third aspect of the present invention, in the article inspection apparatus according to the first aspect, the output means outputs the evaluation result by the evaluation means, as screen display information corresponding to a detection rate of whether the article is a non-defective product or a defective product. Further, according to a fourth aspect of the present invention, in the article inspection apparatus according to the second aspect, the output means outputs the evaluation result by the evaluation means, as screen display information corresponding to a detection rate of whether the article is a non-defective product or a defective product. In these cases, it is possible to easily and accurately grasp the effect of the re-training or the additional training on the inspection performance.

According to a fifth aspect of the present invention, in the article inspection apparatus according to the first aspect, when the trained model is updated by the update means, the evaluation means automatically verifies the trained model by using the verification dataset. Further, according to a sixth aspect of the present invention, in the article inspection apparatus according to the second aspect, when the trained model is updated by the update means, the evaluation means automatically verifies the trained model by using the verification dataset. In this manner, when the trained model is updated by the update means, the old and new trained models before and after the update can be automatically verified by using the verification dataset, and the old and new trained models can be compared and evaluated in a timely manner.

According to a seventh aspect of the present invention, the article inspection apparatus according to the fifth aspect, further includes: recording means for recording an evaluation result from the automatic verification by the evaluation means in a case where the evaluation result is out of a preset evaluation criterion. Further, according to an eighth aspect of the present invention, the article inspection apparatus according to the sixth aspect, further includes: recording means for recording an evaluation result from the automatic verification by the evaluation means in a case where the evaluation result is out of a preset evaluation criterion. In these cases, even when the re-training or the additional training is stopped early at that time, the evaluation result at that time is recorded in a case where the effect of the re-training or the additional training on the inspection performance is not preferable, and thus it is possible to more accurately evaluate the effect on the inspection performance in a case of subsequently performing the learning model update work.

According to a ninth aspect of the present invention, in the article inspection apparatus according to the second aspect, the storage unit stores the verification dataset in an updatable manner. In this manner, verification data with a high user requirement in the actual inspection result, for example, defective product image data to be detected at the vicinity of lower limit accuracy required for the inspection performance, non-defective product image data not to be erroneously determined as a defect, and the like can be added and updated to the verification dataset.

In order to achieve the above object, according to a tenth aspect of the present invention, there is provided a learning model update system that is communicably connected in a data-communicable manner to an article inspection apparatus including a sensor that outputs a detection signal for inspecting a quality state of an article which is sequentially transported, an inspection unit that inspects the quality state of the article by applying a trained model created by training in advance to a predetermined detection signal output by the sensor, and update means for updating the trained model under a condition in which an update request is input from an outside, the learning model update system including: evaluation means for respectively evaluating the trained model before and after the update by the update means, by using a verification dataset which is not used for training the trained model; and output means for outputting an evaluation result by the evaluation means, as statistical data related to an inspection result by the inspection unit with the verification dataset.

With such a configuration, in the learning model update system according to the tenth aspect of the present invention, when the update means updates the trained model for application to the inspection unit via a predetermined medium as an external input in the article inspection apparatus, the trained model before and after the update can be respectively evaluated by the evaluation means by using a verification dataset which is unused for each training. In addition, for the trained model before and after the update, each evaluation result is output by the output means as statistical data related to the inspection result by the inspection unit with the same verification dataset. Therefore, it is possible to accurately compare and evaluate the old and new trained models before and after the update based on each evaluation result by using the same verification dataset, and when the entire learning model is re-trained by partially changing a training algorithm or additionally trained by increasing training image data of a non-defective product or a defective product, it is possible to accurately grasp the effect of the re-training or the additional training on inspection performance, and to reliably prevent a deterioration in inspection performance or the like due to the update of the trained model in advance.

According to an eleventh aspect of the present invention, the learning model update system according to the tenth aspect, further includes: a storage unit that stores a plurality of verification datasets which are not used for training the trained model. In this case, the plurality of verification datasets corresponding to a plurality of types for an inspection object can be stored.

The article inspection apparatus according to the present invention may be an apparatus that irradiates an article with X-rays to acquire an X-ray inspection image and applies a predetermined image processing algorithm to the X-ray inspection image to perform X-ray inspection of a quality state of the article, and may be an apparatus that uses a camera image, which uses various electromagnetic waves other than X-rays, for example, near-infrared rays (NIR), as an inspection image. In addition, without being limited to the camera image, the article inspection apparatus according to the present invention can be applied even in a case where a learning model trained with machine learning is used for inspection determination of an article inspection apparatus such as a metal detector that detects an effect of an article passing through an article inspection region on a magnetic field in the article inspection region as a signal waveform.

### Advantage of the Invention

With the present invention, it is possible to provide an article inspection apparatus and a learning model update system capable of quantitatively grasping a deterioration in inspection performance according to an update of a trained model and reliably preventing a deterioration in yield due to an erroneous detection by an inspection unit in advance, in the update of the trained model.

### BRIEF DESCRIPTION OF THE DRAWINGS

FIG. 1 is a schematic configuration diagram of a main portion of an article inspection apparatus according to an embodiment of the present invention.

FIG. 2 is an explanatory diagram of an example of a verification dataset used for verification of a trained model in the article inspection apparatus according to the embodiment of the present invention.

FIG. 3 is an explanatory diagram of image data constituting one record of the verification dataset used for verification of the trained model and annotation data of the image data, in the article inspection apparatus according to the embodiment of the present invention.

FIG. 4 is a flowchart illustrating an example of a procedure of evaluating an old model before an update using the verification dataset, when updating the trained model in the article inspection apparatus according to the embodiment of the present invention.

FIG. 5 is a flowchart illustrating an example of a procedure of evaluating a new model after the update using the verification dataset and determining whether or not the update is available, when updating the trained model in the article inspection apparatus according to the embodiment of the present invention.

FIG. 6 is an explanatory diagram of a result display screen for comparing and displaying a result obtained by evaluating the old and new trained models before and after the update using the verification dataset, for each record of the verification dataset, when updating the trained model in the article inspection apparatus according to the embodiment of the present invention.

FIG. 7 is an explanatory diagram of an evaluation result total display screen for comparing and displaying a result obtained by evaluating the old and new trained models before and after the update using the verification dataset, for each evaluation item, when updating the trained model in the article inspection apparatus according to the embodiment of the present invention.

FIG. 8 is an explanatory diagram of a limit setting condition for a transition of each of a foreign matter non-detection rate and an erroneous detection rate for a non-defective product according to a detection limit value (1.0 or less) in a case where foreign matter detection performance is evaluated by using the verification dataset, for the trained model in the article inspection apparatus according to the embodiment of the present invention.

FIG. 9 is an explanatory diagram of a comparison display screen illustrating a result obtained by evaluating an effect of additional training of the trained model, for the old and new models using the same verification dataset, in the article inspection apparatus according to the embodiment of the present invention.

FIG. 10 is a schematic configuration diagram of a main portion of a learning model update system of an article inspection apparatus according to another embodiment of the present invention.

### BEST MODE FOR CARRYING OUT THE INVENTION

Hereinafter, embodiments according to the present invention will be described with reference to the drawings.

### One Embodiment

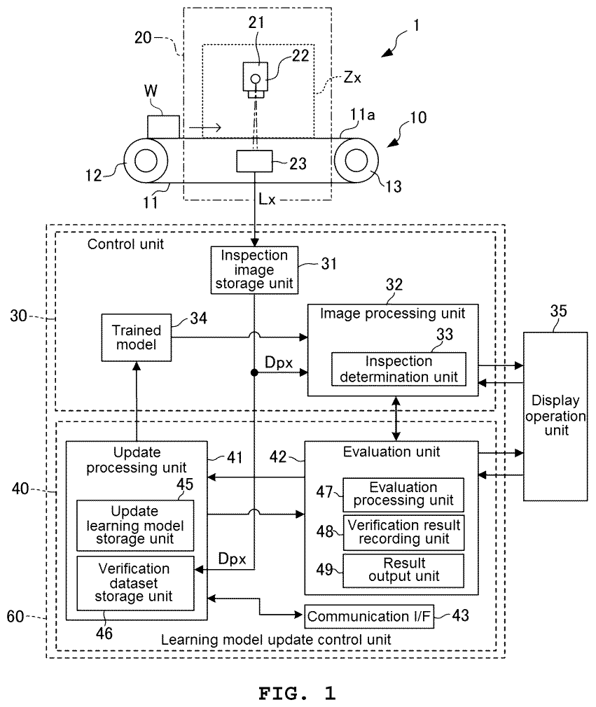

FIGS. 1 to 9 illustrate an article inspection apparatus according to an embodiment of the present invention.

First, a configuration thereof will be described.

As illustrated in FIG. 1, an article inspection apparatus 1 of the present embodiment includes a transport unit 10 that transports an article W which is an inspection article, an inspection unit 20 that inspects the article W being transported, a control unit 30 for main control including control of the transport unit 10 and the inspection unit 20, and a learning model update control unit 40 that executes a predetermined update process on a trained model (details will be described below) constituting a part of the control unit 30. Then, the article inspection apparatus 1 irradiates the article W transported by the transport unit 10 with X-rays by the inspection unit 20, detects image data corresponding to a transmission X-ray amount distribution, and inspects a quality state of the article W based on the image data. The quality state mentioned herein is, for example, the presence or absence of a contained foreign matter, the presence or absence of a missing product, the presence or absence of a defect in shape, size, and storage state of contents, and a distribution of a density, a thickness, a volume, or a mass, which are appropriateness of a quality or a physical quantity required for the article W as a product.

The transport unit 10 is a conveyor capable of sequentially transporting the article W in a right direction in FIG. 1, by winding a loop-shaped transport belt 11 around a plurality of transport rollers 12 and 13 and using an upper running section 11a of the transport belt 11, and is supported by a housing (not illustrated).

The inspection unit 20 is an X-ray inspection unit including an X-ray generator 21 (X-ray source) that generates X-rays in a predetermined energy band, which are transmitted through the article W transported by the transport unit 10, and an X-ray detector 23 disposed directly below the upper running section 11a of the transport belt 11.

The X-ray generator 21 generates X-rays having a wavelength and an intensity corresponding to a tube current and a tube voltage of a known X-ray tube 22, and can irradiate the article W in a predetermined inspection section Zx on the transport belt 11 with fan beam-shaped X-rays in a main observation direction orthogonal to an article transport direction of the transport unit 10 through an X-ray window portion of an outer surrounder (not illustrated in detail).

Although not illustrated in detail, the X-ray detector 23 is configured with an X-ray line scan camera in which detection elements consisting of a scintillator, which is, for example, a phosphor, and a photodiode or a charge coupling element are arranged in an array shape at predetermined pitches in a widthwise direction of a transport path of the transport unit 10 and X-ray detection is performed at a predetermined resolution, and the X-ray detector 23 is disposed at a predetermined position in a transport direction corresponding to an X-ray irradiation position from the X-ray generator 21.

That is, the X-ray detector 23 can detect X-rays which are emitted d from the X-ray generator 21 and transmitted through the article W for each predetermined transmission region corresponding to the detection element, convert the X-rays into an electric signal according to the amount of transmission of the X-rays, and output an X-ray detection signal for generating an X-ray transmission image in which a direction of transmission of the X-rays is an observation direction. Here, the X-rays emitted from the X-ray generator 21 or the X-rays detected by the X-ray detector 23 are assumed to have a certain quality (energy, wavelength) specified according to the quality of the article W, and a so-called dual-energy or multi-energy X-ray image may be generated by using a plurality of types of X-rays having different qualities.

The control unit 30 includes transport control means for controlling a transport speed, a transport interval, and the like of the article W by the transport belt 11 in the transport unit 10, and inspection control means for controlling an X-ray irradiation intensity, an irradiation period, and the like in the inspection unit 20, or controlling an X-ray detection cycle in an X-ray line sensor of the X-ray detector 23 and a detection period of each article W according to the transport speed of the article W. Meanwhile, detailed illustration thereof will be omitted.

The control unit 30 also includes an inspection image storage unit 31 that sequentially receives the X-ray detection signal from the X-ray detector 23 for each predetermined period to acquire the X-ray transmission image of each article W and outputs the image data, an image processing unit 32 that executes an image analysis process such as a predetermined filter process (including a pre-process) capable of extracting an image feature and feature measurement for obtaining a feature amount of the extracted image feature by receiving the image data output from the inspection image storage unit 31, an inspection determination unit 33 that executes a determination process such as a determination of the presence or absence of a predetermined quality state of the article W, for example, a determination of the presence or absence of a contained foreign matter, a determination of the presence or absence of a missing item, and a determination of whether a shape, a size, or a storage state of a content is appropriate, based on data of the feature amount extracted and measured by the image processing unit 32, a trained model 34 that is trained by machine learning to combine a plurality of inspection algorithms to execute the image process used in the image processing unit 32 and the determination process used in the inspection determination unit 33 and to optimize a parameter thereof, and a display operation unit 35 (display device) such as a touch panel that can display and output a determination result by the inspection determination unit 33 and input a request operation such as product type registration.

The control unit 30 is configured to include, for example, a microcomputer having a CPU, a ROM, a RAM, and an I/O interface (not illustrated), an auxiliary storage device that stores a control program, network structure information, a variable, and the like for exhibiting each function of the image processing unit 32, the inspection determination unit 33, and the trained model 34, in cooperation with the ROM in a readable manner, a timer circuit, and the like, and CPU executes a predetermined arithmetic process while exchanging data with the RAM or the like in accordance with the control program stored in the ROM or the like, and executes the control program.

The inspection image storage unit 31 is an image input unit, and for example, performs an operation (hereinafter, referred to as line scanning) of A/D-converting each of the X-ray detection signals from a plurality of detection elements of the X-ray detector 23, and writing, for each predetermined unit transport time corresponding to a detection element size in the X-ray detector 23, the transmission amount of data accumulated within the unit time, for all detection element regions of n detection elements (n is an integer more than 1, for example, 640), as digital data of density levels representing gradations from 0 to 1023, in an image memory.

In addition, the inspection image storage unit 31 has a data processing program and a work memory (not illustrated) that exhibit a function of generating imaging data Dpx (X-ray capturing image data) corresponding to a distribution of the amount of X-rays transmitted through the article W, based on detection data Lx of a line-scanning image sequentially written in the image memory when the line scanning by the X-ray detector 23 is repeated a predetermined number of times of scanning according to an inspection period of the article W, and outputting the imaging data Dpx as imaging data of the article W to the image processing unit 32.

In the image processing unit 32, a predetermined inspection algorithm in which an image processing filter and the like are combined is set and stored in advance, to execute a predetermined article inspection based on the imaging data Dpx of the article W taken in from the inspection image storage unit 31.

The image processing filter included in the inspection algorithm of the image processing unit 32 is a processing program for extracting an image feature (for example, an edge, a line, an angle, a region, a shade, or a texture) required for the predetermined article inspection based on the imaging data Dpx of the article W, and in a case where the inspection algorithm includes a filter for foreign matter detection, the image processing filter is, for example, a feature extraction filter that performs an edge detection process for emphasizing a contour of a foreign matter in the article W, for example, a differential filter such as a Sobel filter, and performs a differential process or the like based on a predetermined arithmetic expression in a region near a pixel of interest to emphasize an edge of the foreign matter. The image processing filter or the like includes a pre-process such as shading correction or noise removal for the imaging data Dpx from the inspection image storage unit 31 to improve detection processing accuracy of the image feature.

In addition, the feature measurement of the image feature executed by the image processing unit 32 is a process of calculating a feature amount required for the determination process in the inspection determination unit 33 by executing calculation of an attribute (feature amount for characterizing an edge, a region, a distance, a position, a shape, and the like) related to a shade feature, a color feature, a shape feature, and the like, the calculation of a feature amount representing a spatial relationship between such features, or calculation of a texture feature amount related to a spatial frequency distribution and a direction component, for an image obtained by performing a necessary pre-process or an image process on the imaging data Dpx of the article W taken in from the inspection image storage unit 31.

The inspection determination unit 33 executes a determination process of determining whether or not a local feature shape or the like corresponding to a foreign matter or a defective portion satisfying a determination condition is included in the article W by detecting the feature shape, the foreign matter, or the like detected in the article W or by comparing the feature amount such as an area, a contour length, and a concentration sum of the detection target with a predetermined determination reference value, based on the feature amount extracted and measured by the image processing unit 32.

The trained model 34 is an inference program obtained by combining a plurality of algorithms including, for example, at least a part of an image processing algorithm used in the image processing unit 32 and at least a part of a determination processing algorithm used in the inspection determination unit 33, incorporating a plurality of parameters (coefficients) in the algorithms as trained parameters obtained by optimizing the parameters using a training dataset, and accurately adjusting a hyper-parameter incorporated before training, and thus the trained model 34 can execute a required image process on the input image data and respectively output a result of the inspection determination based on the image.

In this manner, the control unit 30 applies the predetermined image processing algorithm and the predetermined determination processing algorithm obtained by combining a plurality of filter processes and the like to the imaging data Dpx obtained by imaging the article W having a predetermined type with the inspection unit 20 to inspect a predetermined quality state of the article W.

On the other hand, the learning model update control unit 40 includes an update processing unit 41, an evaluation unit 42, and a communication interface (I/F) 43, and can communicate data with an external management support server via the communication I/F 43.

In the same manner as, for example, the control unit 30, the learning model update control unit 40 is configured to include a microcomputer having a CPU, a ROM, a RAM, and an I/O interface, which are not illustrated, an auxiliary storage device that stores a control program for exhibiting each function of the update processing unit 41, the evaluation unit 42, and the like, which will be described below, in cooperation with the ROM to be readable, and a timer circuit, and the CPU executes a predetermined arithmetic process while exchanging data with the RAM and the like and executes the control program in accordance with the control program stored in the ROM and the like.

Specifically, the update processing unit 41 is configured to execute a predetermined update process of rewriting the trained model 34 as an additional trained model or a re-trained model for an update (hereinafter, referred to as an update model), and is configured to include an update learning model storage unit 45 that stores at least the additional trained model or the re-trained model in a readable and rewriteable manner, and a verification dataset storage unit 46 that stores and holds a dataset that is not used for training of the trained model 34 as a dataset for verification in an updatable manner.

The verification dataset referred to here is a collection of data for a specific purpose processed by a program or a learning model having a training algorithm. Meanwhile, the verification dataset is not training data used for updating weights or the like during machine learning for model construction, but is an unutilized dataset in which prediction performance of classification or regression by the trained model 34 can be evaluated. The verification dataset includes at least test data for evaluating the trained model 34 after training between the test data and verification data which can be used for calculating accuracy for adjusting a hyper-parameter in a stage of re-training or the like.

The evaluation unit 42 has a function of verifying whether or not the current article inspection accuracy using the old model (hereinafter, meaning of old learning model) is impaired with the update process by the update processing unit 41, that is, a process of rewriting and updating the trained model 34 (old model) which is the current AI model to the update learning model stored in the update learning model storage unit 45, and is configured to include includes an evaluation processing unit 47, a verification result recording unit 48, and a result output unit 49.

The evaluation processing unit 47 is evaluation means for first executing an old model evaluation of evaluating the trained model 34, which is an AI model before an update, using a verification dataset stored in the verification dataset storage unit 46 in a predetermined evaluation method (details will be described below), and new model (hereinafter, meaning of new learning model) evaluation of evaluating an update learning model stored in the update learning model storage unit 45 using the verification dataset in the same evaluation method as the old model evaluation, under a condition in which an update request is input from the display operation unit 35 to the update processing unit 41 or the update request is input from an external management support server to the update processing unit 41 via the communication I/F 43.

The verification result recording unit 48 is recording means for recording the evaluation result together with version information of the update learning model as an evaluation target, under a condition in which an evaluation result of at least the evaluation processing unit 47 with automatic verification is out of a preset evaluation criterion, for example, an evaluation result in which the current article inspection accuracy using the old model is assumed to be impaired if the update process by the update processing unit 41 is executed on the update learning model is made.

The result output unit 49 is output means for outputting the evaluation result of the old model evaluation and the new model evaluation by the evaluation processing unit 47 as statistical data (for example, a detection rate of whether the article W is a non-defective product or a defective product) related to the inspection result in the inspection unit 20 using the verification dataset.

More specifically, the update processing unit 41 performs a process of updating the trained model 34 to an additional trained model or a re-trained model in a stepwise manner. For example, a stage of storing the update learning model in the update learning model storage unit 45 in a readable manner is a stage of creating a trial update trained model. In this stage, first, after execution of the old model evaluation using the verification dataset stored in the verification dataset storage unit 46 on the trained model 34 that is the current AI model, the update processing unit 41 executes the new model evaluation using the evaluation dataset as a learning model obtained by provisionally applying the update learning model. Then, each evaluation result is compared, and from a result of the comparative evaluation, under a condition in which the current article inspection accuracy using the old model is assumed to be impaired if the update processing unit 41 executes the update process on the update learning model, the evaluation is made such that the result is out of the preset evaluation criterion, and in other cases, the evaluation is made such that the current article inspection accuracy is not impaired by the execution of the update process.

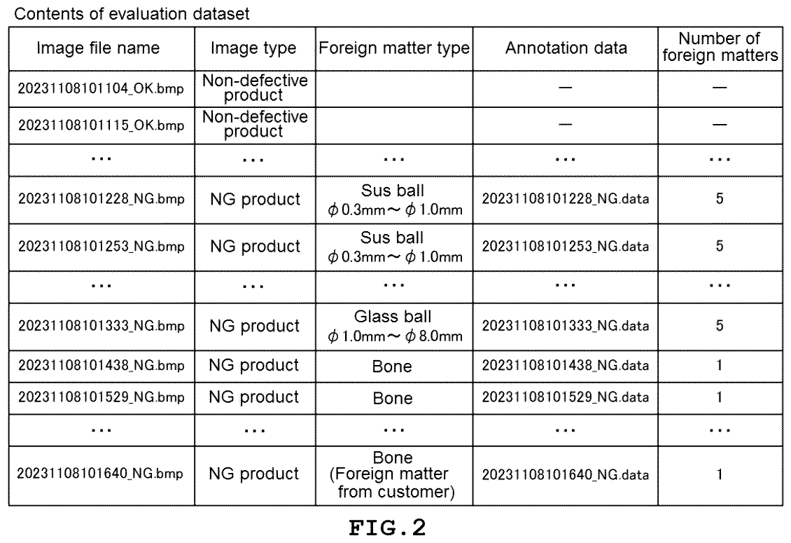

As illustrated in FIG. 2, the verification dataset stored in the verification dataset storage unit 46 in a replenishable and updatable manner is a dataset of image data (exemplified by an image file name in FIG. 2) of each sample for training the trained model 34, a label (exemplified by an image identification label (non-defective product/NG product) and a foreign matter type in FIG. 2) indicating an inspection algorithm suitably applied to and used for the image data, and annotation data (exemplified as annotation data in FIG. 1), and an image in each row in FIG. 2 and a label and/or annotation data suitable for the image are records of one sample.

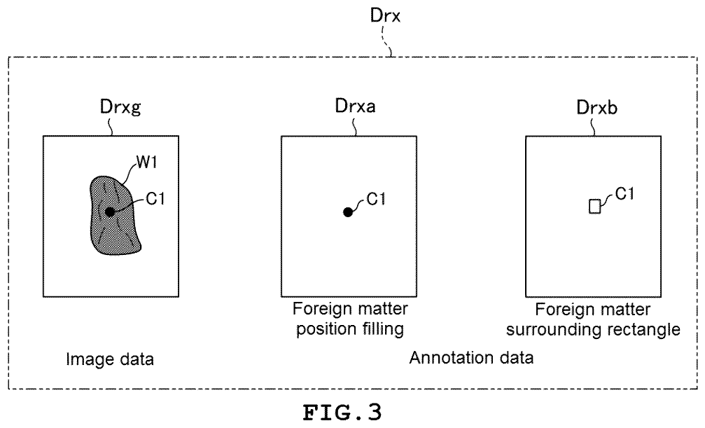

As illustrated in FIG. 3 as an example, a record of the verification dataset is, for example, a dataset Drx including image data Drxg of a meat lump W1 which is the article W, a foreign matter position filling Drxa corresponding to a foreign matter sample C1 (Sus ball, glass ball, and bone in FIG. 3) which is assumed to be mixed with the meat lump W1, and a foreign matter surrounding rectangle Drxb circumscribing a foreign matter having a size of the foreign matter sample C1, approximately. Here, the foreign matter position filling Drxa and the foreign matter surrounding rectangle Drxb are annotation data added as information related to labeling for training with respect to the image data Drxg of the meat lump W1.

In a case where the trained model 34 trained with labeled training data is used, data of an input inspection image based on the imaging data Dpx is image data of which the label is not known.

When the evaluation processing unit 47 executes the old model evaluation and the new model evaluation using the verification dataset, the learning model update control unit 40 configured as described above executes learning model evaluation by the predetermined evaluation method described above in the following procedure.

First, in order to verify inference accuracy of the trained model 34 or the update learning model before an update, image data included in the verification dataset is sequentially incorporated for each record instead of the input inspection image based on the imaging data Dpx, and for example, the image data Drxg of the meat lump W1 illustrated in FIG. 3 is incorporated as data of an input inspection image of which a label is unknown.

Then, the evaluation processing unit 47 executes, for each record of the verification data, an evaluation in which inference results of the old and new models when the image data Drxg of the verification dataset is incorporated as the data of the input inspection image are evaluated based on, for example, annotation data such as the foreign matter position filling Drxa and the foreign matter surrounding rectangle Drxb or identification label information, and the inference accuracy is calculated as a score, for the trained model 34 (old model) that is first stored in the update learning model storage unit 45 and the update model (new model) that is subsequently additionally trained or re-trained.

Further, the evaluation results for a plurality of records are calculated as statistical data related to the inspection result in the inspection unit 20 with the verification dataset, for example, a detection rate of whether the article W is a non-defective product or a defective product (=the number of detections/the number of inspection articles), and is recorded in the verification result recording unit 48 as necessary, and is output as information that can be displayed by the result output unit 49 immediately after the calculation or when a display request is input.

Here, the trained model 34 is obtained by performing a machine learning process, and may be created by a method of deep learning classification using a convolutional neural network or a support vector machine (SVM) that performs class classification of two classes, for example, a non-linear SVM. In addition, the input for training may be numerical data such as an average value, a dispersion value, and a maximum value of pixels, and a product size, instead of the X-ray image itself. Further, in a case where an image is used as the input for training, the image can be not only a transmission image by X-rays but also an image obtained by performing a filter process on a capturing image, in addition to a subtraction image using transmission images in different energy bands, and an image obtained by an imaging method of different optical systems, such as visible light NIR. In addition, an image (for example, JP-A-2023-114827 and JP-A-2023-114828) created by combining a plurality of types of images (each image described above) may be used as in a case where various images are assigned to each channel of a color image such as an RGB image.

In this manner, the article inspection apparatus 1 of the present embodiment acquires data of an input inspection image, which is an X-ray inspection image, by irradiating the transported article W with X-rays by the inspection unit 20, and applies a predetermined image processing algorithm to the data of the input inspection image by the image processing unit 32 to perform X-ray inspection for a quality state of the article W.

In addition, if an update request is input from the display operation unit 35 to the update processing unit 41 or the update request is input from an external management support server to the update processing unit 41 via the communication I/F 43, the article inspection apparatus 1 causes the evaluation processing unit 47 to execute the old model evaluation and the new model evaluation related to the trained model 34, and causes the result output unit 49 to output a result in a displayable manner or causes the verification result recording unit 48 to record the result. Then, whether or not the current article inspection accuracy of the article inspection apparatus 1 is impaired by the update process by the update processing unit 41 is verified by the evaluation unit 42 of the learning model update control unit 40.

Next, the actions will be described.

In the present embodiment configured as described above, in a training stage of the trained model 34, a training dataset including a label or annotation data suitable for each image is prepared by giving the annotation data to each capturing image of a plurality of articles W obtained by imaging a product group having an inspection object type. Then, the trained model 34 that can be associated with any inspection algorithm for conforming data of the input inspection image of the article W is created, by executing a learning process or a machine learning process by, for example, a statistical pattern recognition method using a large number of training datasets.

The trained model 34 created in this manner is stored in the update learning model storage unit 45 of the update processing unit 41 via the communication I/F 43 of the learning model update control unit 40. In addition, at this time, an unutilized dataset that is created as a dataset including image data of the same training sample as the training dataset and the label or the annotation data suitable for the image data, but is not used in the training stage of the trained model 34 is stored in the verification dataset storage unit 46 in an updatable manner as a verification dataset.

Next, in a case where a setting for product type registration is input to the control unit 30 by the display operation unit 35 and the article W for product type registration is test-transported to the article inspection apparatus 1, the article W being transported is irradiated with X-rays by the inspection unit 20, the X-rays transmitted through the article W are detected by the X-ray detector 23, and data of an input inspection image acquired by the inspection image storage unit 31 is subjected to an image process and a determination process by the image processing unit 32 and the inspection determination unit 33 to which the trained model 34 is applied.

In this case, the image process and/or the determination process suitable for the data of the input inspection image is extracted by the trained model 34, and the process is executed.

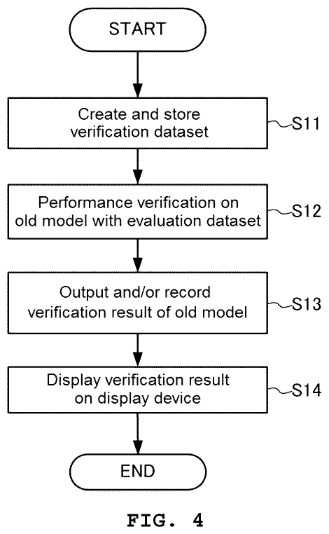

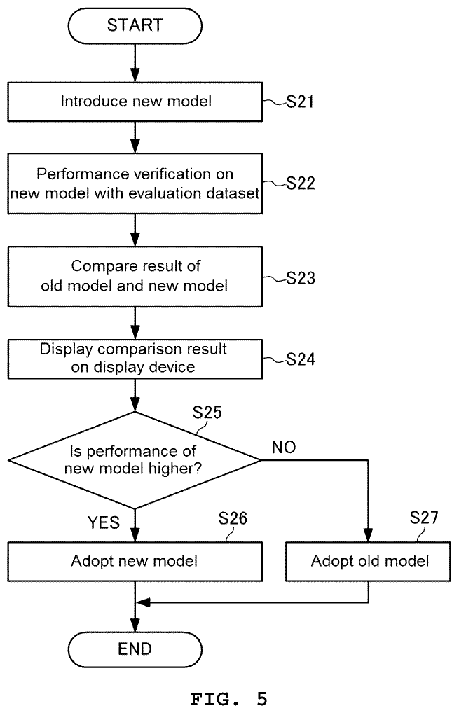

On the other hand, in a case where the trained model 34 is additionally trained or re-trained to be suitable for the article W having the new type, for each of a plurality of records of the verification data, the evaluation processing unit 47 executes evaluation on the old model as illustrated in the procedure in FIG. 4, and then, as illustrated in FIG. 5, executes evaluation on the new model, and the determination is made as to whether or not to perform the update process of the trained model 34 to the update model according to a plurality of evaluation results of each of the old and new models, under a condition in which an update request is input from the display operation unit 35 to the update processing unit 41 or the update request is input from an external management support server to the update processing unit 41 via the communication I/F 43.

That is, as illustrated in FIG. 4, first, a verification dataset including a plurality of records is created and stored by using a verification dataset stored in the verification dataset storage unit 46 or a replenished and updated verification dataset (step S11). Then, the performance verification of the trained model 34, which is an old model before an update, is performed by using image data of each record of the verification dataset and the label or annotation data of the image data by a predetermined evaluation method (a method of verifying learning model inference accuracy for the image data of the verification dataset using the annotation data) (step S12). The result of the performance verification is output from the result output unit 49, is recorded and stored in the verification result recording unit 48 under a predetermined recording condition (step S13), and is displayed on the display operation unit 35 such as a touch panel (step S14).

Next, in a case where the update learning model obtained by additionally training or re-training the trained model 34 is incorporated into the update processing unit 41 and the update learning model is stored in the update learning model storage unit 45 (step S21), performance evaluation is performed on the update learning model (new model) by a predetermined evaluation method using the stored verification dataset or the replenished and updated verification dataset in the verification dataset storage unit 46 (step S22).

Then, the result of the performance evaluation (evaluation value of the inference accuracy) for each of the old model and the new model is compared (step S23), and the comparison result is displayed on a display screen of the display operation unit 35 which is a display device (step S24).

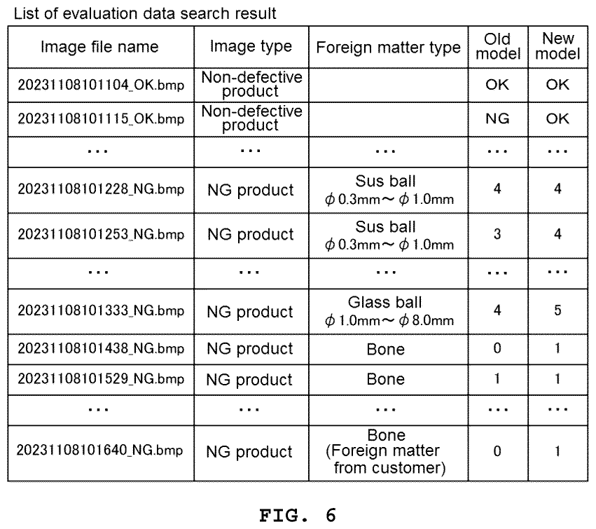

In the comparative evaluation, as illustrated in FIG. 6, for an image type with which a type of whether or not the record of the verification data is a non-defective product or a type of the foreign matter of an NG product is labeled, evaluation data by each of the old model and the new model is displayed as OK or NG or the evaluation value is displayed, and the evaluation result of the old model and the new model for each record can be referred to.

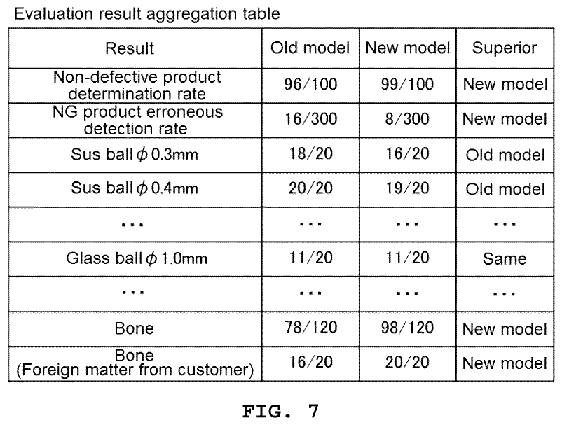

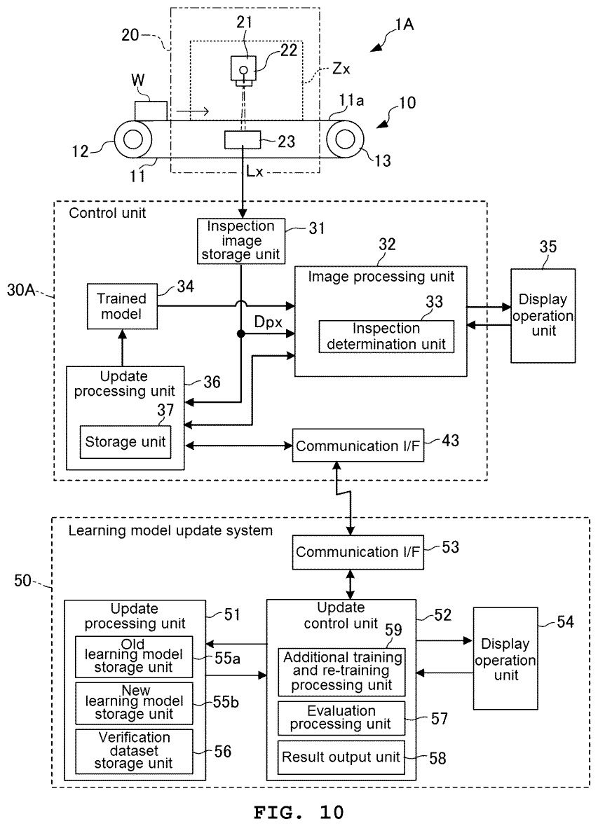

If the evaluation of the old model and the new model for each record of the verification data is ended, next, as illustrated in FIG. 7, by outputting aggregated data (statistical data) that can be displayed in a comparative manner in a form of a non-defective product determination rate (a ratio of OK to data having an image type of a non-defective product), an erroneous detection rate for an NG product (a ratio of OK to data having an image type of NG), a detection rate of a foreign matter sample, and the like, it is easy to understand superiority of the evaluation for the new model to the old model, and a final comparison result is displayed quantitatively, as an evaluation value indicating, for example, a probability that the learning model is superior, as illustrated in FIG. 9.

In this case, at the same time, it is determined whether or not the evaluation value of the performance of the new model is higher than the evaluation of the performance of the old model among the evaluation values of the performance (inference accuracy) of the old model and the new model displayed in a comparative manner on the display operation unit 35 (step S25). In a case where the determination result is YES, the new model is adopted and the update process of the trained model 34 by the update processing unit 41 is executed (step S26), and the current process is ended. On the other hand, in a case where the determination result is NO, the old model is adopted and held (step S27), and the update process of the trained model 34 by the update processing unit 41 is not executed, and the current process is ended.

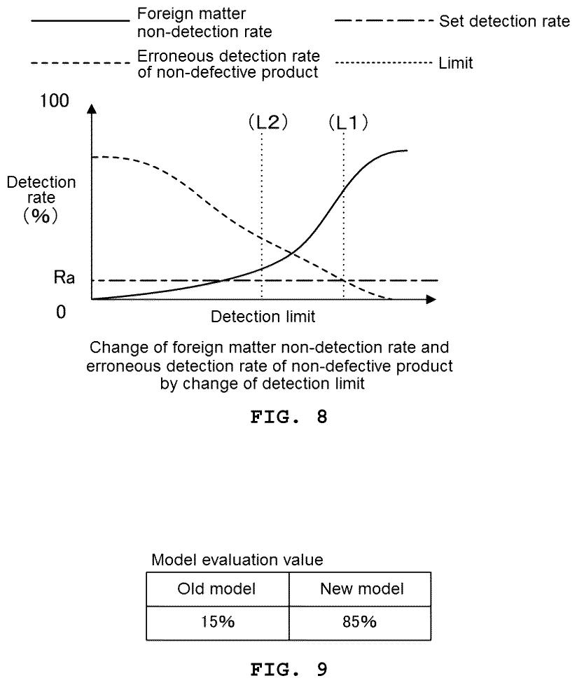

As illustrated in FIG. 8, by setting a detection limit range for determination by a foreign matter detection determination to, for example, the vicinity of a limit value L2, it is possible to sufficiently reduce a foreign matter non-detection rate while allowing a certain degree of an erroneous detection rate for a non-defective product, and in a case where it is desired to suppress the erroneous detection rate of the defective product to a value equal to or less than a desired value, the erroneous detection rate for the non-defective product can be suppressed to a set detection rate Ra by setting the detection limit range to, for example, a limit value L1 corresponding to the detection rate Ra. In this manner, since the erroneous detection rate for the non-defective product and the foreign matter non-detection rate are correlated, in the comparative evaluation, for example, the limits of the old and new models are set such that the erroneous detection rates for the non-defective product are the same, and the foreign matter non-detection rates at that time are compared. Alternatively, the limit of each learning model may be set such that the foreign matter non-detection rates are the same, and the erroneous detection rates for the non-defective product at that time may be compared.

In this manner, in the present embodiment, when the update processing unit 41 of the learning model update control unit 40 tries to update the trained model 34 applied to the control unit 30 for inspection via a predetermined medium, for example, a transmission medium such as a network or a storage medium such as a USB, which is an external input, the evaluation processing unit 47 of the evaluation unit 42 can evaluate performance such as inference accuracy of the old and new trained models before and after the update, respectively, by using a verification dataset that is unused for each training.

In addition, for the old and new models before and after the update, each evaluation result is output by the result output unit 49 as statistical data related to the inspection result of the inspection unit 20 using the same verification dataset, for example, a detection rate of whether the article W is a non-defective product or a defective product (=the number of detections/the number of inspection articles). Therefore, it is possible to accurately compare and evaluate the old and new trained models before and after the update based on each evaluation result by using the same verification dataset, and when the entire learning model of the trained model 34 is re-trained by partially changing a training algorithm or the trained model 34 is additionally trained by increasing training image data of a non-defective product or a defective product, it is possible to accurately grasp the effect of the re-training or the additional training on inspection performance, and to reliably prevent a deterioration in inspection performance or the like due to the update of the trained model 34 in advance.

In the present embodiment, the verification dataset storage unit 46 can store a plurality of verification datasets corresponding to a plurality of types of the inspection object, easily and can and accurately correspond to the production of multiple types. Further, the result output unit 49 can output the evaluation result by the evaluation processing unit 47 as screen display information corresponding to the detection rate of whether the article W is a non-defective product or a defective product, and it is possible to easily and accurately grasp the effect of the re-training or the additional training on the inspection performance.

In the present embodiment, in a case where the trained model is updated by the update processing unit 41, the evaluation processing unit 47 of the evaluation unit 42 automatically verifies the trained model 34 using the verification dataset. Therefore, when the trained model 34 is updated, the old and new trained models before and after the update can be accurately verified by using the verification dataset, and the old and new trained models can be compared and evaluated in a timely manner.

In addition, in the present embodiment, the evaluation result from the automatic verification by the evaluation processing unit 47 is recorded in the verification result recording unit 48 under a condition in which the evaluation result is out of a preset evaluation criterion. Therefore, even when the re-training or the additional training is stopped early at that time, the evaluation result at that time is recorded in a case where it is determined that the effect of the re-training or the additional training on the inspection performance is not preferable, and thus it is possible to more accurately evaluate the effect on the inspection performance in a case of subsequently performing the learning model update work.

In addition, in the present embodiment, since the verification dataset storage unit 46 stores the verification dataset in an updatable manner, verification data with a high user requirement in the actual inspection result, for example, defective product image data to be detected at the vicinity of lower limit accuracy required for the inspection performance, non-defective product image data not to be erroneously determined as a defect, and the like can be added and updated to the verification dataset.

In this manner, with the article inspection apparatus 1 of the present embodiment, it is possible to provide the article inspection apparatus 1 capable of quantitatively grasping a deterioration in inspection performance according to an update of the trained model 34 and reliably preventing a deterioration in yield due to an erroneous detection (erroneous discharge) in advance, in the update of the trained model 34 used for the inspection determination in the inspection unit 20.

### Other Embodiments

FIG. 10 illustrates an article inspection apparatus and a learning model update system according to another embodiment of the present invention.

A learning model update system 50 according to the present embodiment constitutes an external work support server owned by a user, which is disposed in a production factory or the like and is communicably connected in a data-communicable manner to an article inspection apparatus 1A having a main configuration similar to the article inspection apparatus 1 according to the embodiment described above. In the article inspection apparatus 1A, configurations similar to the configurations of the article inspection apparatus 1 of the embodiment are represented by the same reference numerals as those in the embodiment illustrated in FIG. 1 to avoid duplicate description, and only differences will be described.

The article inspection apparatus 1A includes the transport unit 10, the inspection unit 20, and a control unit 30A.

The control unit 30A of the article inspection apparatus 1A is provided with an update processing unit 36 (update means) that performs an update process on the trained model 34 in cooperation with the learning model update system 50, in addition to the inspection image storage unit 31, the image processing unit 32, the inspection determination unit 33, the trained model 34, and the display operation unit 35. The update processing unit 36 includes a storage unit 37 that can store the trained model 34, an update learning model which is additionally trained or re-trained, and verification data.

In addition, the communication I/F 43 capable of being connected to the learning model update system 50 through data communication is provided in the control unit 30A of the article inspection apparatus 1A, and a communication I/F 53 capable of being connected to the control unit 30A through data communication (for example, VPN connection) via the communication I/F 43 is provided in the learning model update system 50.

The learning model update system 50 includes an update processing unit 51, an update control unit 52, and a display operation unit 54, and the update control unit 52 is communicably connected in a data-communicable manner to the article inspection apparatus 1A via the communication I/F 53, and is responsible for delivering data to the update processing unit 51 and the display operation unit 54.

The update processing unit 51 includes an old learning model storage unit 55a that temporarily stores the trained model 34 before an update of which the update is recommended, a new learning model storage unit 55b that temporarily stores an update learning model that is a new model after the update of which the update is recommended, and a verification dataset storage unit 56 that temporarily stores a dataset that is not used for training the trained model 34 before the update as a dataset for verification. The trained model 34 before the update is stored in the old learning model storage unit 55a at a predetermined timing such as a case of comparison with the new model or a case where the new model is mounted on the article inspection apparatus 1A, for example, from another apparatus that manages a trained model owned by the article inspection apparatus 1A or from the article inspection apparatus 1A via the communication I/F 53.

The update control unit 52 includes an additional training and re-training processing that can update the trained model 34, for example, increase the amount of training image data of a non-defective product or a defective product of the article W as an inspection object to perform additional training, or re-train the trained model in accordance with an increase or decrease in network layer constituting the trained model 34, a change in hyper-parameter, or the like. The update control unit 52 may also have a function such as annotation required for training data or verification data.

In addition, the update control unit 52 further includes an evaluation processing unit 57 (evaluation means) that respectively evaluates the trained model 34 before and after the update by the update processing unit 51 using a dataset that is not used for training the trained model 34 as a dataset for verification, and a result output unit 58 (output means) that outputs an evaluation result by the evaluation processing unit 57 as statistical data related to an inspection result by the inspection unit 20 with the verification dataset, for example, a detection rate of whether the article W is a non-defective product or a defective product.

In the learning model update system 50 of the present embodiment configured in this manner, in a case where the trained model 34 provided in the control unit 30A of the article inspection apparatus 1A can be updated by additional training or re-training, the update processing unit 36 of the control unit 30A is notified that the trained model 34 is in an update available state, and the user is notified of the update available state by, for example, displaying a display indicating that the trained model 34 is in the update available state, on an inspection screen or the like displayed by the display operation unit 35.

Then, when the user receives the notification and desires to update the trained model 34 by the display operation unit 35, a data communication path is established between the control unit 30A and the learning model update system 50, and a required update learning model, data, and the like are incorporated into the storage unit 37 of the update processing unit 36, and a learning model update process is executed in a predetermined update procedure.

In addition, prior to the learning model update process, the learning model update system 50 causes the additional training and re-training processing unit 59 to execute a process of performing additional training by increasing training image data of a non-defective product or a defective product of the article W as an inspection object, or a process of re-training the trained model in accordance with an increase or decrease in network layer constituting the trained model 34, a change in hyper-parameter, or the like, under a condition in which a request for the learning model update from the control unit 30A is received.

If the update processing unit 36 executes a work of updating the trained model 34 for application to the inspection unit via a communication interface which is a transmission medium as a predetermined medium in the article inspection apparatus 1A, each of the trained model 34 before the update and the update learning model thereof is evaluated by the evaluation processing unit 57 by using a verification dataset that is unused for each training.

In addition, for the trained model 34 before the update and the update learning model (old and new models), each evaluation result is displayed and output by the result output unit 58 as statistical data related to the inspection result by the inspection unit 20 with the same verification dataset.

Therefore, it is possible to accurately compare and evaluate the old and new trained models before and after the update based on each evaluation result by using the same verification dataset, and when the entire learning model is re-trained by partially changing a training algorithm of the trained model 34 or the trained model 34 is additionally trained by increasing training image data of a non-defective product or a defective product, it is possible to accurately grasp the effect of the re-training or the additional training on inspection performance, and to reliably prevent a deterioration in inspection performance or the like due to the update of the trained model 34 in advance.

The article inspection apparatus according to the present invention may be an apparatus that irradiates an article with X-rays to acquire an X-ray inspection image and applies a predetermined image processing algorithm to the X-ray inspection image to perform X-ray inspection of a quality state of the article, and may be an apparatus that uses a camera image, which uses various electromagnetic waves other than X-rays, for example, near-infrared rays (NIR), as an inspection image. In addition, without being limited to the camera image, the article inspection apparatus according to the present invention can be applied even in a case where a learning model trained with machine learning is used for inspection determination of an article inspection apparatus such as a metal detector that detects an effect of an article passing through an article inspection region on a magnetic field in the article inspection region as a signal waveform.

In addition, although the learning model update system 50 is connected to one article inspection apparatus for an article in FIG. 10, the learning model update system 50 can be connected to a plurality of article inspection apparatuses, and update a learning model for the plurality of article inspection apparatuses in a production factory for an inspection article.

Further, the update of the trained model 34 is also applicable in a case where the learning model update system 50 receives a new model from a manufacturer via a predetermined medium, for example, a transmission medium such as a network or a storage medium such as a USB, and the user may exchange the learning model between the learning model update system 50 and the article inspection apparatus 1A via the transmission medium or the storage medium such as a USB at a predetermined timing.

As described above, the present invention can provide an article inspection apparatus and a learning model update system capable of quantitatively grasping a deterioration in inspection performance according to an update of a trained model and reliably preventing a deterioration in yield due to an erroneous detection by an inspection unit in advance, in the update of the trained model. The present invention is useful for an article inspection apparatus that inspects a quality state of an article by applying a trained model to an inspection image or a sensor signal according to the quality state of the article, and in general, a learning model update system that supports an update of the trained model.

### DESCRIPTION OF REFERENCE NUMERALS AND SIGNS

1, 1A: article inspection apparatus
10: transport unit
11: transport belt
11a: upper running section
12, 13: transport roller
20: inspection unit (X-ray inspection unit)
21: X-ray generator
22: X-ray tube
23: X-ray detector
23: sensor
30, 30A: control unit (inspection control unit)
31: inspection image storage unit (image input unit)
32: image processing unit
33: inspection determination unit
34: trained learning model
35, 54: display operation unit
36: update processing unit
37: storage unit
40: learning model update control unit
41, 51: update processing unit (update means)
42: evaluation unit
43, 53: communication I/F (communication interface)
45: update learning model storage unit
46, 56: verification dataset storage unit (storage unit)
47, 57: evaluation processing unit (evaluation means)
48: verification result recording unit (recording means)
49, 58: result output unit (output means)
50: learning model update system
52: update control unit
55a: old learning model storage unit
55b: new learning model storage unit
59: additional training and re-training processing unit
60: overall control unit
C1: foreign matter sample
Dpx: imaging data
Drx: verification dataset (one record)
Drxg: image data
Drxa: foreign matter position filling (annotation data)
Drxb: foreign matter surrounding rectangle (annotation data)
L1, L2: limit value
Lx: detection data
W: article (inspection article, product)
W1: meat lump (article, inspection article, product)
Zx: inspection section

What is claimed is:

1. An article inspection apparatus comprising:
a sensor that outputs a detection signal for inspecting a quality state of an article which is sequentially transported;
an inspection unit that inspects the quality state of the article by applying a trained model created by training in advance to a predetermined detection signal output by the sensor;
update means for updating the trained model under a condition in which an update request is input from an outside;
evaluation means for evaluating the trained model by using a verification dataset which is not used for training the trained model; and
output means for outputting an evaluation result by the evaluation means, as statistical data related to an inspection result by the inspection unit with the verification dataset.

2. The article inspection apparatus according to claim 1, further comprising:
a storage unit that stores a plurality of verification datasets which are not used for training the trained model.

3. The article inspection apparatus according to claim 1,
wherein the output means outputs the evaluation result by the evaluation means, as screen display information corresponding to a detection rate of whether the article is a non-defective product or a defective product.

4. The article inspection apparatus according to claim 2,
wherein the output means outputs the evaluation result by the evaluation means, as screen display information corresponding to a detection rate of whether the article is a non-defective product or a defective product.

5. The article inspection apparatus according to claim 1,
wherein when the trained model is updated by the update means, the evaluation means automatically verifies the trained model by using the verification dataset.

6. The article inspection apparatus according to claim 2,
wherein when the trained model is updated by the update means, the evaluation means automatically verifies the trained model by using the verification dataset.

7. The article inspection apparatus according to claim 5, further comprising:
recording means for recording an evaluation result from the automatic verification by the evaluation means in a case where the evaluation result is out of a preset evaluation criterion.

8. The article inspection apparatus according to claim 6, further comprising:
recording means for recording an evaluation result from the automatic verification by the evaluation means in a case where the evaluation result is out of a preset evaluation criterion.

9. The article inspection apparatus according to claim 2,
wherein the storage unit stores the verification dataset in an updatable manner.

10. A learning model update system that is communicably connected in a data-communicable manner to an article inspection apparatus including
a sensor that outputs a detection signal for inspecting a quality state of an article which is sequentially transported,
an inspection unit that inspects the quality state of the article by applying a trained model created by training in advance to a predetermined detection signal output by the sensor, and
update means for updating the trained model under a condition in which an update request is input from an outside, the learning model update system comprising:
evaluation means for respectively evaluating the trained model before and after the update by the update means, by using a verification dataset which is not used for training the trained model; and
output means for outputting an evaluation result by the evaluation means, as statistical data related to an inspection result by the inspection unit with the verification dataset.

11. The learning model update system according to claim 10, further comprising:
a storage unit that stores a plurality of verification datasets which are not used for training the trained model.
